(19) United States
(12) Patent Application Publication
(10) Pub. No.: US 2019/0050839 A1
(43) Pub. Date: Feb. 14, 2019

(54) RECEIPT PRINTER AND RECEIPT PRINTER CONTROL METHOD

(71) Applicant: SEIKO EPSON CORPORATION, Tokyo (JP)

(72) Inventors: Takayoshi NAMIKOSHI, Shiojiri-shi (JP); Haruyoshi OHORI, Matsumoto-shi (JP); Hikonosuke UWAI, Azumino-shi (JP)

(73) Assignee: SEIKO EPSON CORPORATION, Tokyo (JP)

(21) Appl. No.: 16/058,524

(22) Filed: Aug. 8, 2018

(30) Foreign Application Priority Data
Aug. 10, 2017 (JP) 2017-155115

(51) Int. Cl. G06Q 20/20

(52) U.S. Cl. CPC G06Q 20/209

(57) ABSTRACT

A receipt printer according to the invention includes a first communication section, a second communication section, a printing mechanism, a memory, and a processor. The processor receives receipt print information including POS data via the first communication section, generates receipt information including generation data generated in accordance with the receipt print information and processing history information, performs at least one of processing for causing a printing mechanism to print a receipt in accordance with the receipt print information and processing for transmitting receipt information to an external device via the second communication section, and includes in the processing history information information indicating details of the receipt information having been processed.

### CROSS REFERENCE TO RELATED APPLICATIONS

This application is based upon and claims the benefit of the prior Japanese Patent Application No. 2017-155115, filed on Aug. 10, 2017, the entire contents of which are incorporated herein by reference.

### BACKGROUND

### 1. Technical Field

The present invention relates to a receipt printer and a receipt printer control method.

### 2. Related Art

For example, when a customer buys goods at a store and pays for them, a sales receipt is issued to the customer as a voucher for the payment. The sales receipt may be a receipt printed on a medium (hereinafter simply referred to as a receipt) or electronic data including the electronically recorded payment contents.

As a technique of this kind, for example, JP-A-2009-42931 discloses a system in which a payment processing apparatus creates electronic data of payment contents, and a determination is made as to whether or not a receipt is issued in accordance with receive permission information set in advance. In this system, the payment processing apparatus stores the created electronic data in a database. A customer who has not received a receipt in accordance with the receive permission information is able to obtain the receipt by visiting the store later and reading and printing the electronic data stored in the database via the payment processing apparatus.

Incidentally, in recent years, some customers perform domestic bookkeeping, such as keeping household accounts using household accounting software installed on a home personal computer (PC), or the like. In such a case, if a printed receipt is issued, each time a customer obtains such a receipt, the customer has to enter the printed contents of the receipt into the PC, which is a burden. Accordingly, it is preferable for the customer to record the information (payment contents) of a receipt directly from the electronic data of the payment contents. Also, it is preferable to facilitate copying and transferring of electronic data of the payment contents so that the electronic data may be used in a variety of electronic devices, not only in the PC described above. Further, it is preferable that a customer be able to print a receipt from the electronic data whenever the customer needs a receipt as a voucher.

However, a receipt is a voucher of expenditure at the time of tax processing, and the like, and thus it is necessary to prevent duplicates, or the like. Accordingly, customers have not been allowed to freely copy and transfer electronic data. For example, in the system described in JP-A-2009-42931, when a customer needs a receipt, the customer has to visit a store where a payment processing apparatus is installed and obtain the receipt by printing the receipt via the payment processing apparatus to prevent unauthorized operations, such as duplicate issues of a receipt, which is used as a voucher, or the like.

### SUMMARY

An advantage of some aspects of the invention is obtained by realizing a receipt printer and a receipt printer control method as the following embodiments.

According to an embodiment of the invention, there is provided a receipt printer including: a printing mechanism configured to print a receipt as a sales receipt; a memory configured to store a control program; and a processor configured to read the control program from the memory and execute the control program, wherein the processor receives receipt print information including POS data regarding the purchases from a POS accounting apparatus for performing accounting processing regarding purchases made by a customer, generates receipt information including generation data in accordance with the receipt print information and processing history information, and performs at least one of processing for causing the printing mechanism to print the receipt in accordance with the receipt print information and processing for transmitting the receipt information to a external device different from the POS accounting apparatus, and includes in the processing history information information indicating details of the receipt information having been processed.

With this configuration, the receipt printer receives receipt print information including POS data regarding the purchases from the POS accounting apparatus and generates receipt information including generation data based on the receipt print information and the processing history information. Further, the receipt printer performs at least one of processing for causing the printing mechanism to print a receipt in accordance with the receipt print information and processing for transmitting the receipt information to an external device via the second communication section, and includes information indicating the details of the receipt information having been processed in the processing history information. Accordingly, it is possible for the receipt printer to print a receipt as a printed matter or transmit receipt information including generation data generated in accordance with the receipt print information and the processing history information to the external device. Further, since the processing history information includes information indicating the details of the receipt information having been processed, it is possible for the external device that has received the receipt information to perform processing for avoiding duplicate issues of the receipt in accordance with the processing history information.

In the above-described embodiment, the processor preferably generates as the generation data at least one of text data in accordance with the POS data and image data of the receipt as an electronic receipt.

With this configuration, the generation data generated in accordance with the receipt print information includes at least one of text data based on the POS data and image data of the receipt. Accordingly, if the generation data includes the text data, it is possible for the customer to directly capture the information (payment contents) of the receipt in a PC, or the like from the text data in the receipt information transmitted to the external device. Also, if the generation data includes the image data of the receipt, it is possible for the customer to display the image of the receipt on the display unit, or the like of the external device from the image data.

In the above-described embodiment, if the processor has caused printing of the receipt, the processor preferably includes in the processing history information printed information indicating completion of printing the receipt, and if the processor transmits the receipt information to the external device, the processor preferably includes in the processing history information at least one of information identifying the receipt printer of a transmission source, information identifying the external device of a transmission destination, and date and time information of transmission to the external device.

With this configuration, if the processor causes printing of the receipt, the processor includes the printed information in the processing history information. If the processor transmits the receipt information to an external device, the processor includes at least one of the information identifying the receipt printer, the information identifying the external device, and the date and time information of the transmission in the processing history information. Accordingly, by the processing history information, it becomes obvious that the receipt has been printed, or it becomes easy to get the detailed information on the point in time when the receipt information was transmitted.

In the above-described embodiment, the processing history information preferably includes a print flag indicating whether or not the receipt has been printed, and if the processor includes in the processing history information printed information indicating completion of printing the receipt, the processor preferably sets the print flag to a state indicating completion of printing.

With this configuration, the processing history information includes a print flag, and if the processor includes the printed information in the processing history information, the processor sets the print flag to a state indicating completion of the printing. Accordingly, it becomes obvious whether or not the receipt has been printed by the state of the print flag.

In the above-described embodiment, if the processor has printed the receipt, the processor preferably deletes at least part of the data of the electronic receipt from the generation data.

With this configuration, if the processor has printed a receipt, the processor deletes at least part of the data of the electronic receipt from the generation data. Accordingly, it is not possible to print the original (formal) receipt from the electronic receipt from which part of the data has been deleted, and thus it is possible to avoid duplicate issues of the receipt.

In the above-described embodiment, if the processor has printed the receipt, the processor preferably adds data indicating completion of printing the receipt to the electronic receipt.

With this configuration, data indicating that the receipt has been printed is added to the electronic receipt. Accordingly, it is not possible to print the original (formal) receipt from the electronic receipt to which other data has been added, and thus it is possible to prevent duplicate issues of the receipt.

According to another embodiment of the invention, there is provided a method of controlling a receipt printer including a printing mechanism configured to print a receipt as a sales receipt, a memory configured to store a control program, and a processor configured to read the control program from the memory and execute the control program, the method including: receiving receipt print information including POS data regarding the purchases from the POS accounting apparatus for performing accounting processing regarding purchases made by a customer; generating receipt information including generation data in accordance with the receipt print information and processing history information; performing at least one of processing for causing the printing mechanism to print the receipt in accordance with the receipt print information and processing for transmitting the receipt information to a external device different from the POS accounting apparatus; and including in the processing history information information indicating details of the receipt information having been processed.

By this method, a receipt printer receives receipt print information including POS data from a POS accounting apparatus, generates receipt information including generation data and processing history information, and performs at least one of processing for causing the printing mechanism to print the receipt and processing for transmitting the receipt information to an external device. Also, the processing history information includes the processing history information indicating the details of the receipt information having been processed. Accordingly, it is possible for the receipt printer to print the receipt as a printed matter or transmit the receipt information including generation data generated in accordance with the receipt print information and the processing history information to the external device. Further, since the processing history information includes information indicating the details of the receipt information having been processed, it is possible for the external device that has received the receipt information to perform processing for avoiding duplicate issues of the receipt in accordance with the processing history information.

### BRIEF DESCRIPTION OF THE DRAWINGS

The invention will be described with reference to the accompanying drawings, wherein like numbers reference like elements.

FIG. 1 is a diagram illustrating an example of the configuration of a receipt information processing system.

FIG. 2 is a functional configuration diagram of the receipt information processing system.

FIG. 3 is a flowchart illustrating the operation of the receipt information processing system.

FIG. 4 is a flowchart illustrating the operation of the receipt information processing system.

FIG. 5 is a diagram illustrating the structure of receipt information.

FIG. 6A is a diagram illustrating a specific example of receipt information.

FIG. 6B is a diagram illustrating a specific example of the receipt information.

FIG. 7A is a diagram illustrating a specific example of the receipt information.

FIG. 7B is a diagram illustrating a specific example of the receipt information.

FIG. 8 is a diagram illustrating a specific example of the receipt information.

FIG. 9A is a diagram illustrating a specific example of the receipt information.

FIG. 9B is a diagram illustrating a specific example of the receipt information.

FIG. 10 is a diagram illustrating a specific example of the receipt information.

FIG. 11 is a diagram illustrating the structure of receipt information.

### DESCRIPTION OF EXEMPLARY EMBODIMENTS

### Embodiments

A description will be given of embodiments of the invention with reference to the drawings. In the present embodiment, a description will be given of a receipt information processing system 100 as an example. The receipt information processing system 100 includes a receipt printer 2 to which the invention is applied, a POS (point of sale) accounting apparatus 1, a smartphone 3, a smart watch 5, a home printer 4 (second printer), a personal computer 6 (PC 6), and a data server 7. In this regard, the smartphone 3 and the smart watch 5 are user terminals (examples of external devices), and the home printer 4, the PC 6, and the data server 7 are peripheral devices.

Also, in the diagrams referenced in the following description, members or parts are sometimes illustrated with horizontal and vertical scales that differ from the actual scales for convenience of explanation and illustration. Also, components other than those necessary for the explanation are sometimes omitted in the illustrations.

Overall configuration of receipt information processing system

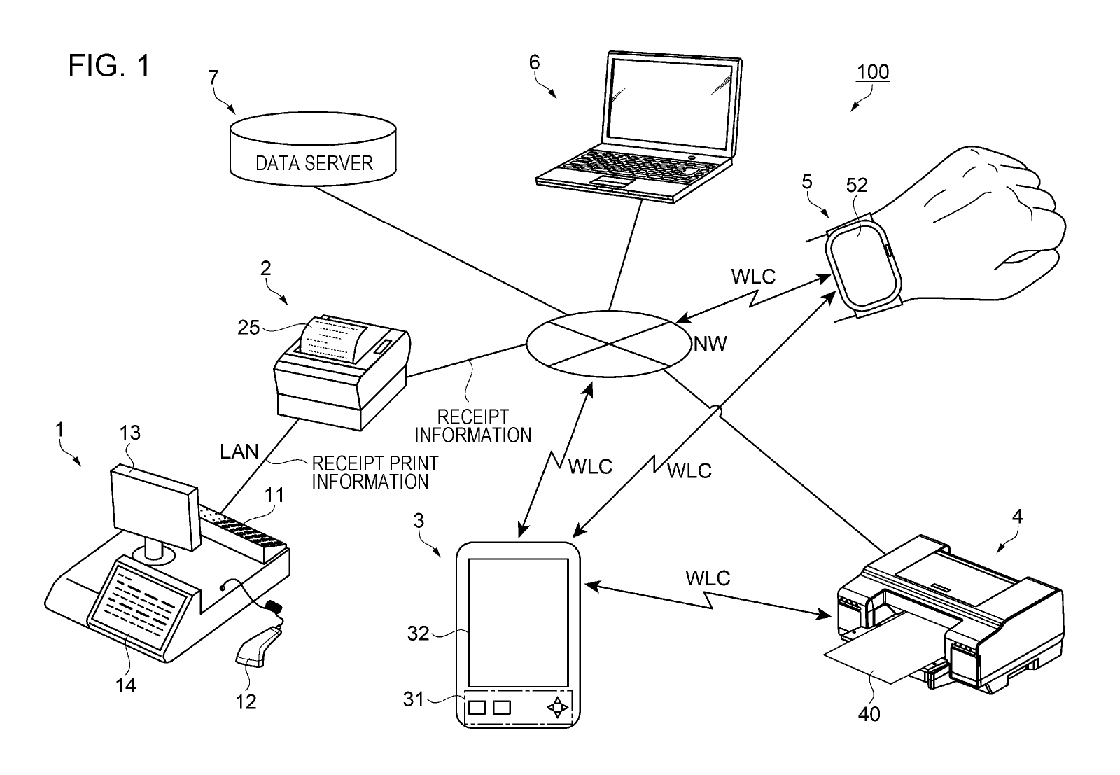

First, a description will be given of the overall configuration of the receipt information processing system 100 with reference to FIG. 1. FIG. 1 is a diagram illustrating an example of the configuration of the receipt information processing system 100. As illustrated in FIG. 1, in the receipt information processing system 100 according to the present embodiment, the POS accounting apparatus 1, which performs accounting processing regarding purchases made by a customer, and the receipt printer 2, which issues a sales receipt (a printed receipt 25 or an electronic receipt) to be handed to the customer, are connected via a LAN (local area network). Also, the receipt printer 2 is communicably connected to the smartphone 3, the home printer 4, the smart watch 5, the PC 6, and the data server 7 via a network NW (for example, the Internet).

The POS accounting apparatus 1 is, for example, a POS cash register that is installed in a store where the customer buys goods and that calculates and records the sales amount of the products purchased by the customer. When information (product name, product number, quantity, and the like) of the products is entered using a keyboard 11 or a barcode reader 12, the POS accounting apparatus 1 calculates the total amount in accordance with the stored unit prices, and the like and displays the product information and the total amount on a display panel 13 and a customer display 14 such that a store clerk and the customer can confirm the contents. Then when the customer completes the payment, the POS accounting apparatus 1 transmits the receipt print information to the receipt printer 2 to issue the receipt 25 as a sales receipt. The receipt print information includes POS data, such as the name, price, and quantity of products sold, date and time, and store of purchase, and the like. The receipt print information may include a print layout command that determines the print layout of the receipt 25 in the receipt printer 2 or the image data of the receipt 25. The image data of the receipt 25 is an electronic receipt that is a digitized image of the printed receipt 25.

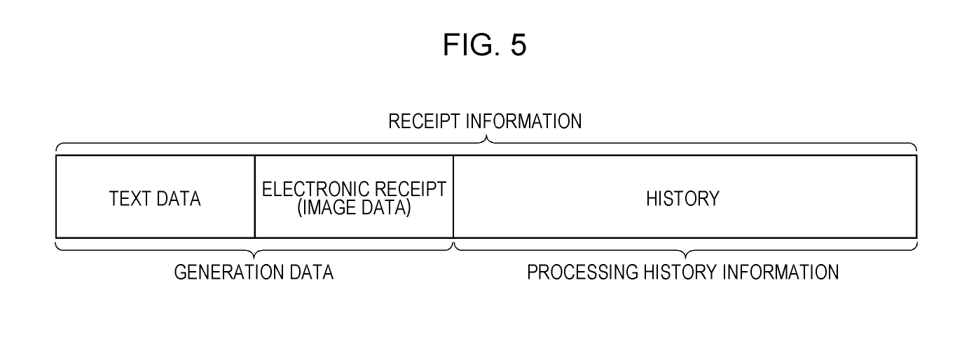

The receipt printer 2 is, for example, a thermal printer or a dot impact printer installed in the same store as the store where the POS accounting apparatus 1 is installed. The receipt printer 2 prints the receipt 25 to be handed to the customer as a sales receipt or generates receipt information (refer to FIG. 5, and details will be described later) in accordance with the receipt print information sent from the POS accounting apparatus 1.

The home printer 4 is, for example, an ink jet printer or a laser printer and prints, on a print medium 40, the print data transmitted from the host device. In the present embodiment, the home printer 4 is a printer installed in an environment in which the customer is capable of suitably using the printer with ease. In the receipt information processing system 100, the home printer 4 is connected to the network NW, and thus the smartphone 3, the smart watch 5, the PC 6, or the like is capable of functioning as a host device of the home printer 4.

The smartphone 3 is a mobile information terminal including a mobile device OS (operating system) and is capable of voice communication and information communication via a network NW, and the like. Also, the smartphone 3 is capable of transmitting print data to the home printer 4 by short-range wireless communication WLC, such as Bluetooth (registered trademark), Wi-Fi (registered trademark: Wireless Fidelity), ZigBee (registered trademark), NFC (near field communication), or the like without using a network NW and communicating with the smart watch 5. The smartphone 3 includes an input section 31 and a touch panel 32 on which information is displayed and is caused to operate by a user operating the input section 31 and the touch panel 32.

The smart watch 5 is a wrist-type mobile information terminal, which is worn on the wrist of a customer. The smart watch 5 includes a touch panel 52 and an input section (hidden) and has equivalent functions to those of the smartphone 3. The smart watch 5 is capable of communicating with the smartphone 3 by short-range wireless communication WLC without using a network NW.

In this regard, the receipt information processing system 100 may include a plurality of smartphones 3, SmartWatches 5, tablet terminals, and the like as user terminals.

The data server 7 is a storage device that stores and shares data and includes a computer having sufficient memory to serve as a database, an HDD (hard disk drive), RAID (redundant arrays of independent disks), and the like.

In this regard, the POS accounting apparatus 1 and the receipt printer 2 may be configured to have, for example, a USB (Universal Serial Bus) connection. Also, the receipt printer 2 may communicate directly with the smartphone 3 by the short-range wireless communication WLC without using the network NW, and the smartphone 3 may communicate with the home printer 4, the smart watch 5, the PC 6, the data server 7, or the like via the network NW.

Operation of receipt information processing system

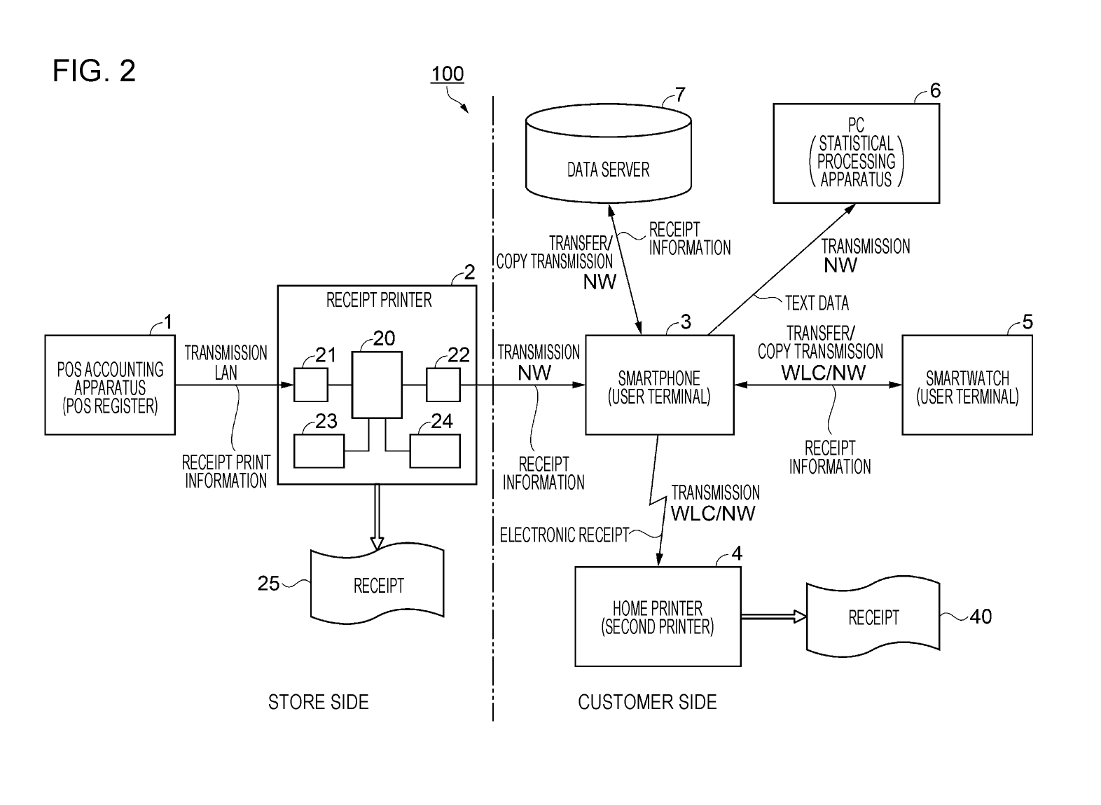

Next, a description will be given of a receipt information processing method (that is to say, the operation of the receipt information processing system 100 and the information flow among components) in accordance with FIG. 2 to FIG. 4 and with reference to FIG. 5 to FIG. 10.

FIG. 2 is a functional configuration diagram of the receipt information processing system 100 based on the functions of each component and the information flow.

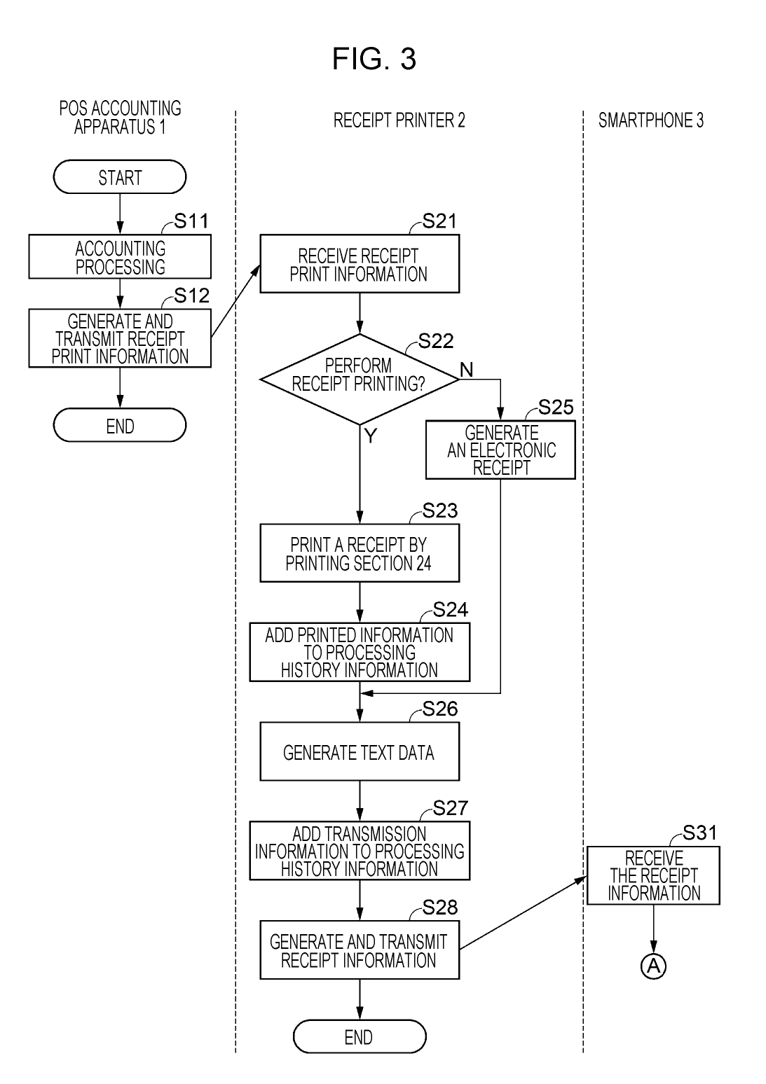

FIG. 3 is a flowchart illustrating the operation of the receipt information processing system 100 and is a diagram for explaining mainly the operation of the POS accounting apparatus 1 and the receipt printer 2.

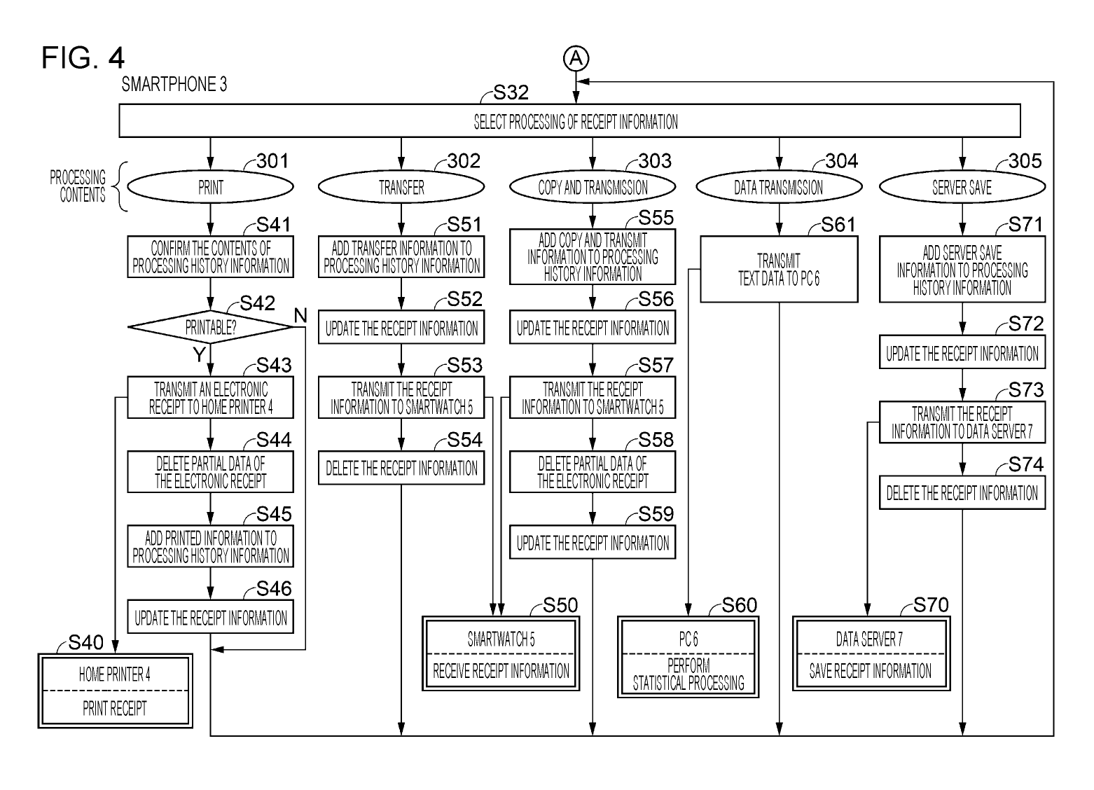

FIG. 4 is a flowchart illustrating the operation of the receipt information processing system 100 and is a diagram for explaining the cooperative operation of the home printer 4, the smart watch 5, the PC 6, and the data server 7 with a central focus on the operation of the smartphone 3.

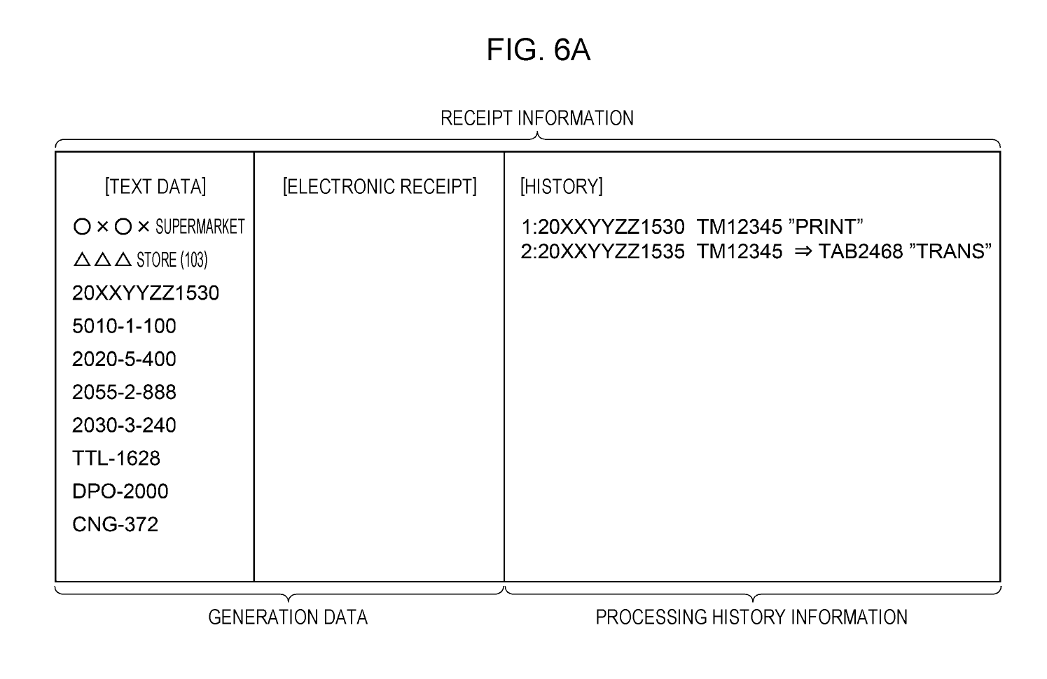

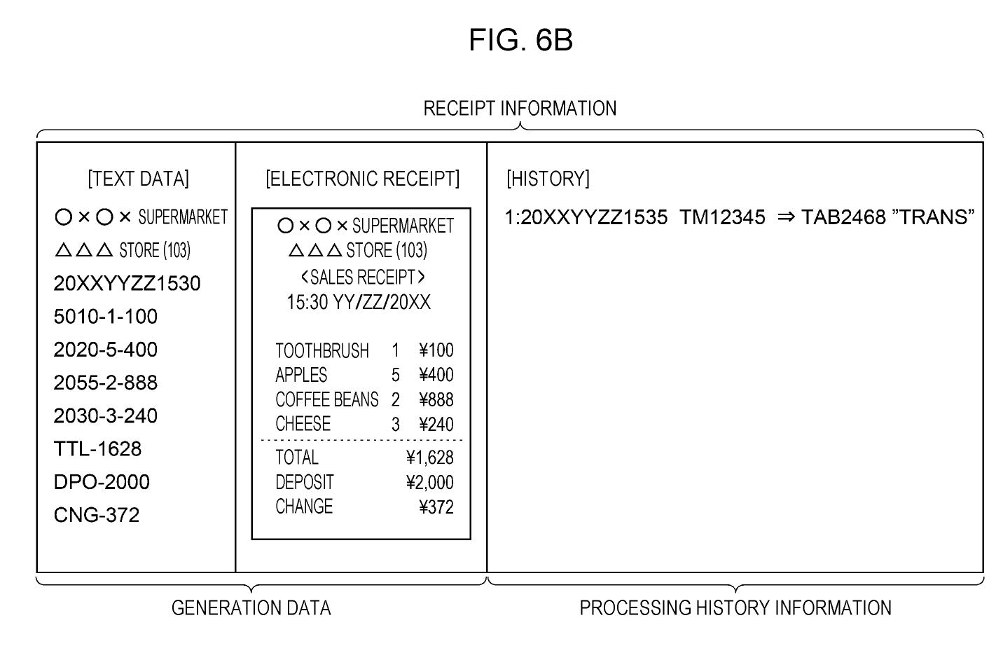

FIG. 5 is a diagram illustrating the structure of receipt information. FIG. 6A to FIG. 10 are diagrams illustrating specific examples of the receipt information.

The POS accounting apparatus 1 and the receipt printer 2 are connected via a LAN in the store (refer to FIG. 2), and the POS accounting apparatus 1 performs accounting processing (step S11 in FIG. 3). The generated receipt print information described above is transmitted to the receipt printer 2 (step S12 in FIG. 3).

A description will be given of the configuration and the operation (control method) of the receipt printer 2 that receives the receipt print information.

Configuration of Receipt Printer

As illustrated in FIG. 2, the receipt printer 2 includes a control section 20, a first communication section 21, a second communication section 22, a storage section 23, and a printing section 24. The control section 20, the first communication section 21, the second communication section 22, the storage section 23, and the printing section 24 are connected via a data bus, or the like, and are capable of exchanging data under the control of the data control section 20.

The first communication section 21 is an interface (I/F) for communicating with the POS accounting apparatus 1 under the control of the control section 20 and includes a communication circuit, a communication IC (integrated circuit), and the like (receiver and transmitter, communication circuit, communication board, communication port, connector). The first communication section 21 performs information communication in accordance with the communication protocol of the LAN.

The second communication section 22 is an interface (I/F) for communicating with the smartphone 3 under the control of the control section 20 and includes a communication circuit, a communication IC (integrated circuit), and the like (receiver and transmitter, communication circuit, communication board, communication port, connector). The second communication section 22 performs information communication in accordance with the communication protocol of the network NW.

The storage section 23 is memory for storing a control program (firmware) that controls the operation of the receipt printer 2 and for reserving a work area for the control section 20. The storage section 23 is a memory device, such as a ROM (read-only memory), an EEPROM (electrically erasable programmable read-only memory), a RAM (random access memory), or the like, or a storage device, such as an HDD, or the like.

The printing section 24 includes a print mechanism and a drive circuit of the print mechanism and the like and is controlled by the control section 20 to print the receipt 25. The print mechanism includes a transport mechanism that transports a medium (for example, continuous paper in a roll state) on which POS data is printed, a print head that prints on the medium, and a cutter mechanism that cuts the printed medium to provide the receipt 25 in a specific form, and the like.

The control section 20 includes a CPU (central processing unit, processor) that performs operation in accordance with the control program stored in the storage section 23 to control the first communication section 21, the second communication section 22, and the printing section 24. Also, the control section 20 generates the receipt information (refer to FIG. 5, and details will be described later) in accordance with the receipt print information. The control section 20 may include a RAM, a ROM, an ASIC (application specific integrated circuit), and the like.

Here, a description will be given of the receipt information generated by the control section 20 (eventually by the receipt printer 2). As illustrated in FIG. 5, the receipt information includes the generation data generated in accordance with the receipt print information and the processing history information indicating a history (details) of the receipt information having been processed. More specifically, the generation data includes text data and an electronic receipt (image data). The text data is generated from the POS data of the receipt print information, and the electronic receipt is the image data produced by digitizing the print image of the receipt 25 generated by the POS data and the print layout command.

In the present embodiment, a description will be given based on the assumption that the electronic receipt is generated from the POS data and the print layout command in the receipt printer 2. In this regard, the electronic receipt may be generated by the POS accounting apparatus 1 and included in the receipt print information to be transmitted to the receipt printer 2. In the processing history information, information indicating the details of the generated receipt information having been processed is recorded.

Operation of Receipt Printer

As illustrated in FIG. 3, the control section 20 of the receipt printer 2 controls the first communication section 21 so as to receive the receipt print information from the POS accounting apparatus 1 (step S21).

The control section 20 that has received the receipt print information determines whether or not to print the receipt 25 to be handed to the customer in accordance with an instruction from the POS accounting apparatus 1 (step S22). As a result, if the receipt printer 2 prints the receipt 25 (Y in step S22), the processing proceeds to step S23, whereas if the receipt printer 2 does not print the receipt 25 (N in step S22), the processing proceeds to step S25.

If the receipt printer 2 prints the receipt 25 (Y in step S22), the control section 20 controls the printing section 24 so as to print the receipt 25 in accordance with the POS data and the print layout command included in the receipt print information (step S23). Next, the control section 20 records in (adds to) the processing history information printed information indicating that the receipt 25 has been printed, and the processing proceeds to step S26 (step S24).

FIG. 6A is a diagram illustrating a specific example of the receipt information generated by the receipt printer 2 when the receipt printer 2 has printed the receipt 25. The receipt information in FIG. 6A is generated after the processing from step S24 to step S28 is performed but is disclosed here in advance to describe the processing history information. As illustrated in FIG. 6A, in the processing history information, “20XXYYZZ1530 TM12345“PRINT”” is recorded in step S24 with a serial number “1” as the printed information. The printed information indicates that the processing is executed at 15:30 on day ZZ of month YY in year 20XX by the beginning date and time information “20XXYYZZ1530” and that the processing is printing ““PRINT”” performed by a receipt printer 2 having a unique number of “TM12345”, which is the information for identifying a receipt printer 2, by the subsequent “TM12345“PRINT””.

On the other hand, if the control section 20 does not print the receipt 25 (N in step S22), the control section 20 generates an electronic receipt from the POS data and the print layout command, and the processing proceeds to step S26 (step S25).

FIG. 6B is a diagram illustrating a specific example of the receipt information generated by the receipt printer 2 when the receipt printer 2 does not print the receipt 25. The receipt information in FIG. 6B is generated after the processing from step S25 to step S28 is performed but is disclosed here in advance to describe the electronic receipt. As illustrated in FIG. 6B, the electronic receipt (image data) generated in step S25 is recorded in the generation data.

Subsequent to step S24 or step S25, the control section 20 generates text data from the POS data (step S26). The text data is data of the information (payment contents) described on the receipt 25, which is expressed by a character string. Thereby, it is possible for the PC 6, or the like, which performs domestic bookkeeping, to directly capture the payment contents.

Specifically, as illustrated in FIG. 6A and FIG. 6B, the text data is recorded in the generation data. As is understood from FIG. 6B, the contents of the text data matches those of the electronic receipt. That is to say, “20XXYYZZ1530” of the text data corresponds to “15:30 YY/ZZ in 20XX” of the electronic receipt. The character sting “5010-1-100” in the text data corresponds to “toothbrush 1 Y100” in the electronic receipt. The beginning “5010” indicates the product number of a toothbrush, the next “1” indicates sales quantity, and the last “100” indicates the unit price of the toothbrush. In the same manner, a product number, sales quantity, and a unit price are recorded in this order in the text data for apples, coffee beans, and cheese. Further, “TTL-1628”, “DPO-2000”, and “CNG-372” in the text data indicates “total ¥1,628”, “deposit ¥2,000”, and “change ¥372” of the electronic receipt respectively.

Next, the control section 20 records (adds) information indicating that the receipt information has been transmitted to the smartphone 3 in the processing history information (step S27) in preparation for transmitting the receipt information to be generated to the smartphone 3.

Specifically, as illustrated in the serial number “2” in the processing history information in FIG. 6A and the serial number “1” in the processing history information in FIG. 6B, “20XXYYZZ1535 TM12345⇒TAB2468“TRANS”” is recorded in the processing history information as the information indicating that the receipt information has been transmitted to the smartphone 3. The character string “20XXYYZZ1535 TM12345⇒TAB2468“TRANS”” indicates that the receipt information has been transmitted (“TRANS”) at “15:35 YY/ZZ/20XX” from the receipt printer 2 having the unique number “TM12345” to the smartphone 3 having the unique number “TAB2468”, which is the information for identifying an external device.

Next, the control section 20 generates receipt information including the text data generated in step S26 and the processing history information generated in step S27 (refer to FIG. 6A). Also, if the receipt 25 has not been printed, the control section 20 generates the receipt information (refer to FIG. 6B) including the electronic receipt generated in step S25 in addition to the text data and the processing history information. The control section 20 then transmits the generated receipt information to the smartphone 3 (step S28).

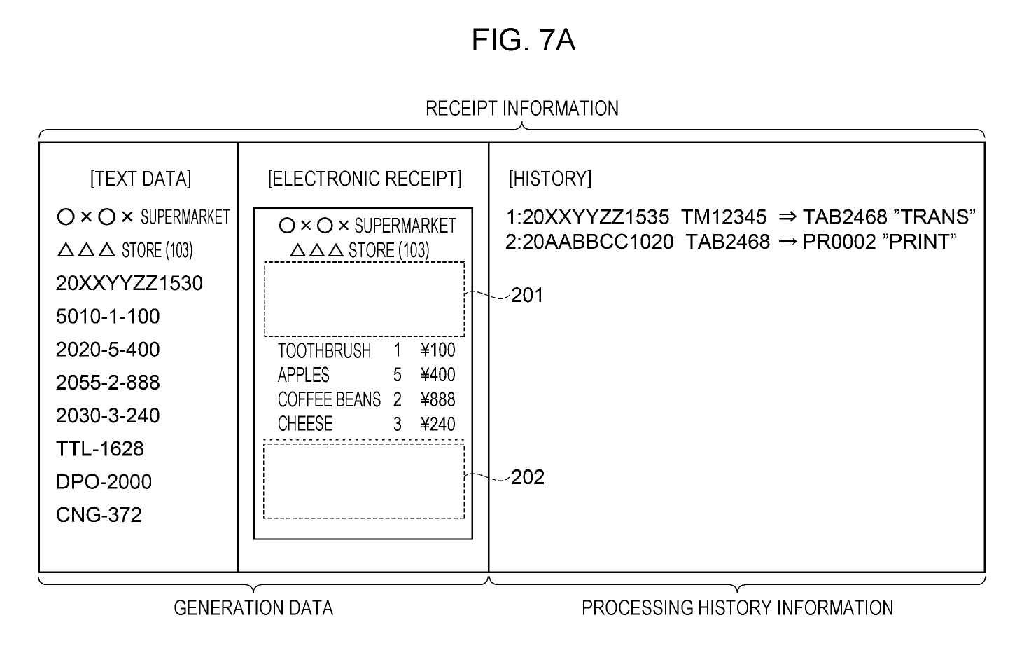

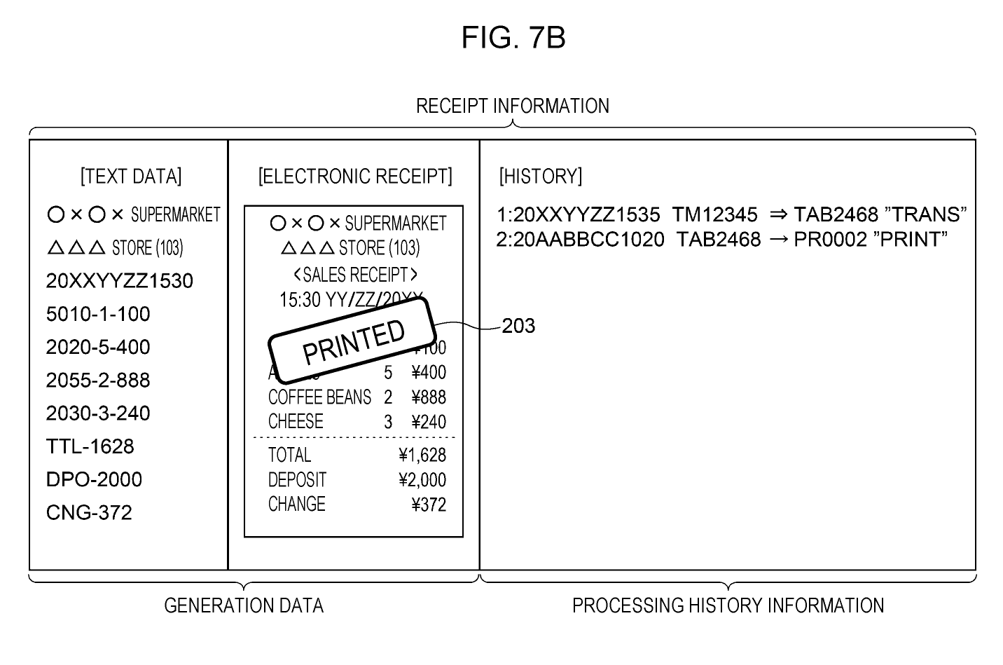

In this regard, here the example in which when the receipt printer 2 has printed the receipt 25, receipt information is generated without including an electronic receipt is illustrated. However, the receipt information may be generated by including the electronic receipt part of the data of which has been deleted. The detailed description will be given later of an electronic receipt part of the data of which has been deleted (refer to FIG. 7A). Since part of the data has been deleted from the electronic receipt, the electronic receipt is not the original (formal) electronic receipt. That is to say, the receipt information includes an electronic receipt that is not the image data of the original (formal) receipt 25.

Also, if the receipt printer 2 has printed the receipt 25, data indicating that the electronic receipt has been printed may be added to the electronic receipt. The detailed description will be given of the electronic receipt to which data indicating that the electronic receipt has been printed is added (refer to FIG. 7B). Since the form of the electronic receipt is changed, this electronic receipt is not the original (formal) electronic receipt. That is to say, the receipt information includes an electronic receipt that is not the image data of the original (formal) receipt 25.

The smartphone 3 receives the receipt information transmitted from the receipt printer 2 (step S31). If the receipt information includes electronic receipt (image data) (refer to FIG. 6B), it is possible for the smartphone 3 to display the electronic receipt (image data) on the touch panel 32 in response to a request of a customer, or the like.

Also, as illustrated in FIG. 2, it is possible for the smartphone 3 that has received receipt information to transmit the receipt information or part of the receipt information to the smart watch 5 as another user terminal or the home printer 4, the PC 6, and the data server 7 as a peripheral device in order to perform processing, for example, the processing as described below.

The smartphone 3 transmits the electronic receipt, which is part of the receipt information, to the home printer 4 by short-range wireless communication WLC and causes the home printer 4 to print the electronic receipt on the print medium 40. As a result, the printed receipt is created.

Also, the smartphone 3 performs transfer or copy transmission of the receipt information via the network NW so as to transmit the receipt information to the smart watch 5. Here, the transfer refers to passing the receipt information to the smart watch 5 of the transmission destination without keeping (without holding) the receipt information in the smartphone 3 of the transmission source. Copy transmission refers to transmitting the receipt information to the smart watch 5 of the transmission destination with keeping (holding) the receipt information in the smartphone 3 of the transmission source.

Also, the smartphone 3 transmits text data, which is part of the receipt information, to the PC 6 via the network NW. The PC 6 receives the text data and performs, for example, domestic bookkeeping using the text data by the installed household accounting software, or the like.

Also, the smartphone 3 transmits the receipt information to the data server 7 by transfer or copy transmission of the receipt information via the network NW. The data server 7 stores the transmitted receipt information.

When the above-described processing is performed, if the receipt information is transferred, the receipt information is not remained in the transmission source, and thus the uniqueness of the electronic receipt is guaranteed as a voucher. On the other hand, if the receipt information is subjected to copy transmission, the receipt information is held both by the transmission source and the transmission destination. In the invention, the receipt information held either by the transmission source or the transmission destination is subjected to predetermined processing, and thus the uniqueness of the electronic receipt is guaranteed. Accordingly, an illegal action, such as duplicate issues of a receipt to be a voucher, or the like is prevented.

In the following, a detailed description will be given of the flow of the receipt information in the above-described processing and the predetermined processing applied to the receipt information with reference to the flowchart in FIG. 4.

After the smartphone 3 receives the receipt information transmitted from the receipt printer 2 (step S31 in FIG. 3), the smartphone 3 causes the customer to suitably select processing to be performed on the receipt information (step S32 in FIG. 4). Specifically, the smartphone 3 causes the customer to select one of the processing to be performed among print processing 301, transfer processing 302, copy transmission processing 303, data transmission processing 304, and server save processing 305.

If the print processing 301 is selected by the smartphone 3, the smartphone 3 confirms whether or not there is printed information in the processing history information of the receipt information in order to avoid duplicate issues of the receipt (step S41), and determines whether or not the electronic receipt is allowed to be printed (step S42).

If the electronic receipt was printed in the past (there is printed information), the electronic receipt is not printed in order to avoid duplicate issues of the receipt, and the processing returns to step S32 (N in step S42). In this case, the smartphone 3 may display information that the receipt is not allowed to be printed, or the like on the touch panel 32 or inform the customer of this fact by alarm sound in order to inform the customer of the fact that the receipt was printed in the past.

On the other hand, if the electronic receipt was not printed in the past (if there is no printed information), the smartphone 3 determines that the electronic receipt is allowed to be printed (the receipt is allowed to be issued), and the processing proceeds to step S43 (Y in step S42). If the smartphone 3 determines that the electronic receipt can be printed, the smartphone 3 transmits the electronic receipt to the home printer 4 (step S43). The home printer 4 to which the smartphone 3 has transmitted the electronic receipt prints the electronic receipt on the print medium 40 (step S40).

Next, the smartphone 3 deletes part of the data of the electronic receipt (an example of the predetermined processing: step S44) in order to avoid an illegal action, such as duplicate issues of a receipt, or the like, and records (adds) the printed information in the processing history information (step S45). After that, the smartphone 3 updates the holding receipt information with the electronic receipt processed in step S44 and the processing history information to which the information has been added in step S45, and the processing returns to step S32 (step S46).

FIG. 7A is a diagram illustrating a specific example of the receipt information updated in step S46. As is apparent from the comparison between FIG. 6B and FIG. 7A, the receipt information illustrated in FIG. 7A is produced by deleting in step S44 a deletion portion 201 and a deletion portion 202 from the electronic receipt of the receipt information in FIG. 6B. More specifically, in the electronic receipt in FIG. 7A, a title “<sales receipt>” and date and time “15:30 YY/ZZ/20XX” (deletion portion 201) are deleted and “total ⇒1,628”, “deposit ⇒2,000”, and “change ⇒372” (deletion portion 202) are deleted from the electronic receipt in FIG. 6B.

FIG. 7B is a diagram illustrating another specific example of the receipt information. The example in FIG. 7B is produced by adding, in step S44, data 203 indicating that the electronic receipt was printed in the past (that is to say, the receipt was issued in the past) to the electronic receipt as predetermined processing in place of deleting part of the data of the electronic receipt. The data 203 is image data including a word “PRINTED” and is overlaid on the electronic receipt.

Also, as illustrated in FIG. 7A and FIG. 7B, for the serial number “2” of the processing history information of the receipt information, “20AABBCC1020 TAB2468→PR0002“PRINT”” is recorded as the printed information added in step S45. That is to say, “20AABBCC1020 TAB2468→PR0002“PRINT”” indicates that the receipt information was transmitted from the smartphone 3 having the unique number “TAB2468” to the home printer 4 having the unique number “PR0002” at 10:20 on BB/CC/20AA″ and is printed (“PRINT”).

Next, a description will be given of the processing flow and the form of the receipt information when the transfer processing 302 is selected by the smartphone 3. Here, a description will be given of the case where the receipt information is transferred from the smartphone 3 to the smart watch 5 as an example.

In preparation for transferring the receipt information to the smart watch 5, the smartphone 3 adds the information indicating that the receipt information has been transferred in the processing history information (step S51), and updates the holding receipt information to the processing history information to which the information has been added (step S52). Next, the smartphone 3 transmits the updated receipt information to the smart watch 5 (step S53). The smart watch 5 to which the receipt information has been transmitted from the smartphone 3 receives the receipt information (step S50). After that, the smartphone 3 deletes the holding receipt information in order to guarantee the uniqueness of the receipt information including the electronic receipt, and the processing returns to step S32 (step S54).

By the above transfer processing 302, the receipt information is deleted from the smartphone 3, and the original receipt information is held by the smart watch 5.

In this regard, original receipt information refers to receipt information having generation data including text data and an electronic receipt, to which no processing has been applied. Also, even if information is added to the processing history information, the receipt information having the generation data that is not processed is referred to as original receipt information.

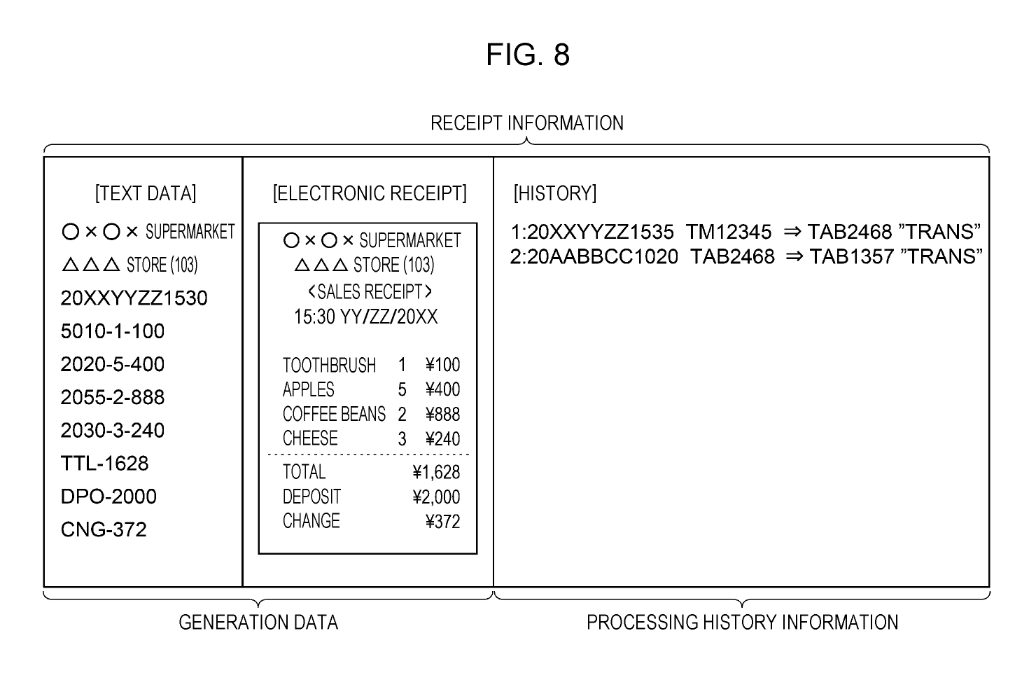

FIG. 8 is a diagram illustrating a specific example of receipt information updated in step S52. As illustrated in FIG. 8, for the serial number “2” of the processing history information of the receipt information, “20AABBCC1020 TAB2468⇒TAB1357“TRANS”” is recorded as information indicating that the receipt information added in step S51 is transferred. That is to say, “20AABBCC1020 TAB2468⇒TAB1357“TRANS”” indicates that the receipt information is transferred (“TRANS”) from the smartphone 3 having the unique number “TAB2468” to the smart watch 5 having the unique number “TAB1357” at “10:20 BB/CC/20AA”.

Next, a description will be given of the processing flow and the form of the receipt information when the copy transmission processing 303 is selected by the smartphone 3. Here, a description will be given of the case where the receipt information is subjected to copy transmission from the smartphone 3 to the smart watch 5 as an example.

In preparation for copy transferring the receipt information to the smart watch 5, the smartphone 3 adds the information indicating that the receipt information is copy transmitted to the processing history information (step S55), and updates the holding receipt information to the processing history information to which the information has been added (step S56). Next, the smartphone 3 transmits the updated receipt information to the smart watch 5 (step S57). The smart watch 5 to which the receipt information has been transmitted from the smartphone 3 receives the receipt information (step S50). After that, the smartphone 3 deletes part of the data of the electronic receipt in order to avoid illegal action, such as duplicate issues of a receipt, or the like (an example of copied processing: step S58). Next, the smartphone 3 updates the holding receipt information with the electronic receipt of which part of the data has been deleted in step S58 and the processing history information to which the information has been added in step S55, and the processing returns to step S32 (step S59).

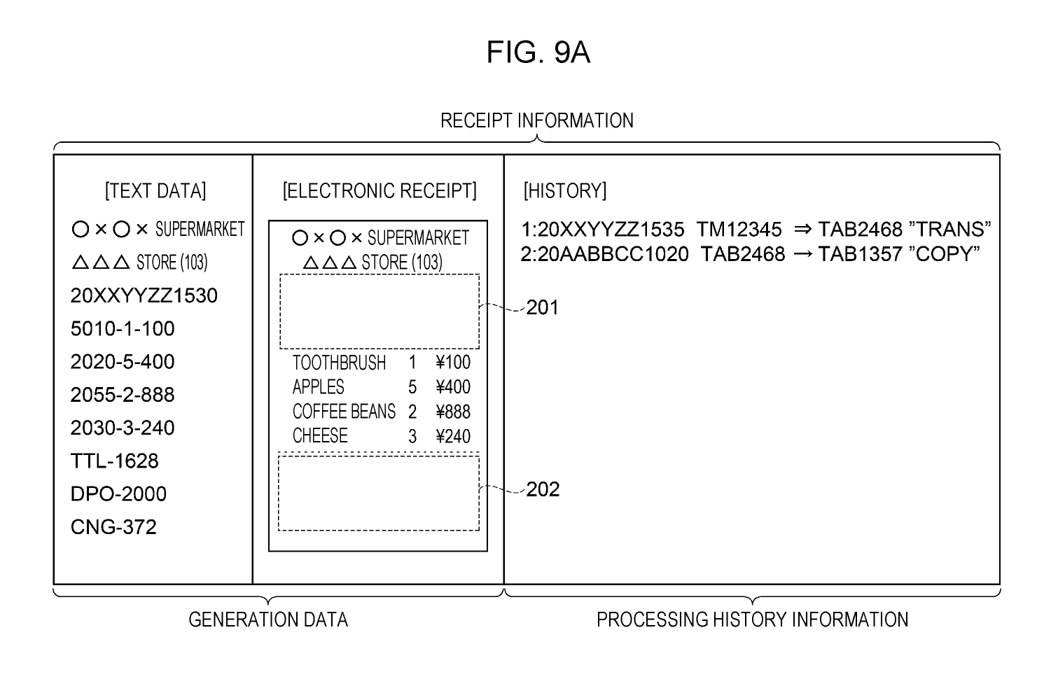

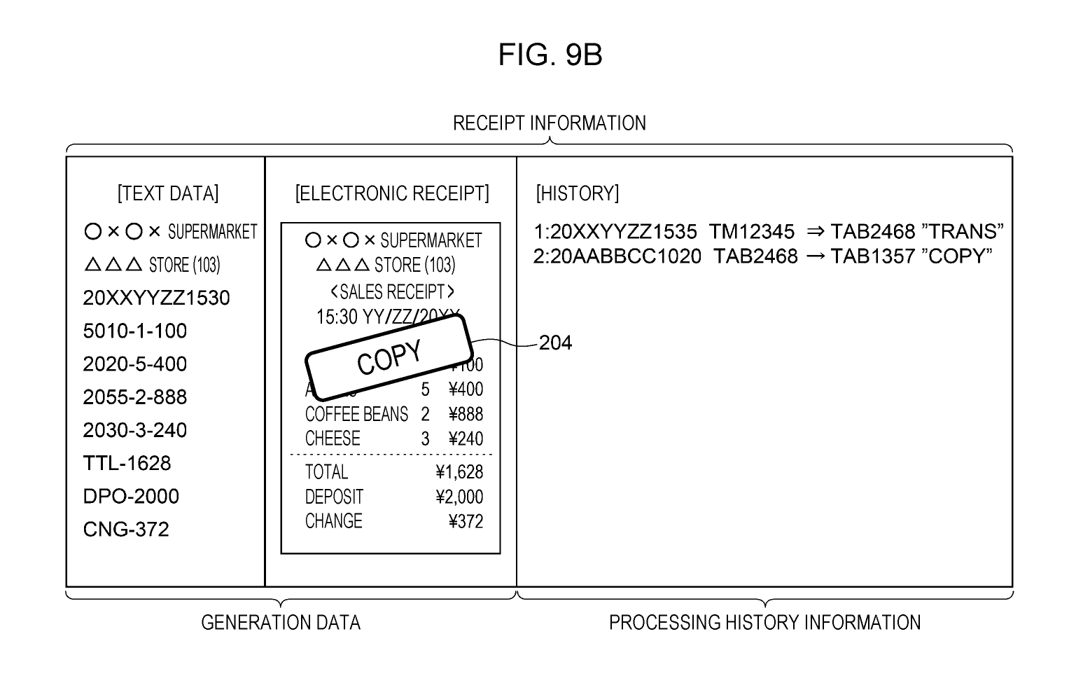

FIG. 9A is a diagram illustrating a specific example of receipt information updated in step S59. As is apparent from the comparison between FIG. 6B and FIG. 9A, the receipt information illustrated in FIG. 9A is produced by deleting, in step S58, the deletion portion 201 and the deletion portion 202 from the electronic receipt of the receipt information in FIG. 6B as the copied processing. The deleted contents are equivalent to the description in FIG. 7A.

FIG. 9B is a diagram illustrating another specific example of receipt information. The example in FIG. 9B is produced by adding data 204 indicating that the electronic receipt was subjected to copy transmission in the past in place of deleting part of the data as copied processing in step S58. The data 204 is image data including a word “COPY” and is overlaid on the electronic receipt.

Also, as illustrated in FIG. 9A and FIG. 9B, for the serial number “2” in the processing history information in the receipt information, “20AABBCC1020 TAB2468⇒TAB1357“COPY”” is recorded as the information indicating that the receipt information added in step S55 has been subjected to copy transmission. That is to say, “20AABBCC1020 TAB2468⇒TAB1357“COPY”” indicates that the receipt information was subjected to copy transmission (“COPY”) from the smartphone 3 having the unique number “TAB2468” to the smart watch 5 having the unique number “TAB1357” at “10:20 BB/CC/20AA”.

In this regard, although a description with reference to a flowchart is omitted, it is possible to configure the copy transmission processing 303 such that the smartphone 3 holds the original receipt information, and the smart watch 5 holds the receipt information indicating that copied processing has been performed. Specifically, for example, in step S56, the processing history information is updated to the updated receipt information, and the updated receipt information is held by the smartphone 3. For the receipt information to be transmitted the smart watch 5 in step S57, partial data of the receipt information is deleted and updated in step S58 and step S59. Thereby the smartphone 3 holds the original receipt information, and the smart watch 5 holds the receipt information having been subjected to copied processing.

Next, a description will be given of the data transmission processing 304 in which the smartphone 3 transmits text data, which is part of receipt information, to the PC 6 in order for the PC 6 to perform domestic bookkeeping.

The smartphone 3 selects text data from the holding receipt information and transmits the text data to the PC 6 via the network NW (step S61). The PC 6 receives the text data and performs domestic bookkeeping, such as creating a household accounts book, or the like (step S60).

When the smartphone 3 performs the data transmission processing 304, the smartphone 3 does not change the form of the receipt information. Accordingly, the smartphone 3 holds the original receipt information before and after the data transmission processing 304 is performed.

Next, a description will be given of the processing flow and the form of the receipt information when the server save processing 305 is selected by the smartphone 3.

In preparation for storing the receipt information in the data server 7, the smartphone 3 adds server save information indicating that the receipt information has been saved in the server to the processing history information (step S71) and updates the holding receipt information to the processing history information to which the server save information is added (step S72). Next, the smartphone 3 transmits the updated receipt information to the data server 7 (step S73). The data server 7 to which the smartphone 3 has transmitted the receipt information receives the receipt information (step S70). After that, the smartphone 3 deletes the holding receipt information in order to guarantee the uniqueness of the receipt information including the electronic receipt, and the processing returns to step S32 (step S74).

By the above-described server save processing 305, the receipt information is deleted from the smartphone 3, and the data server 7 saves the original receipt information.

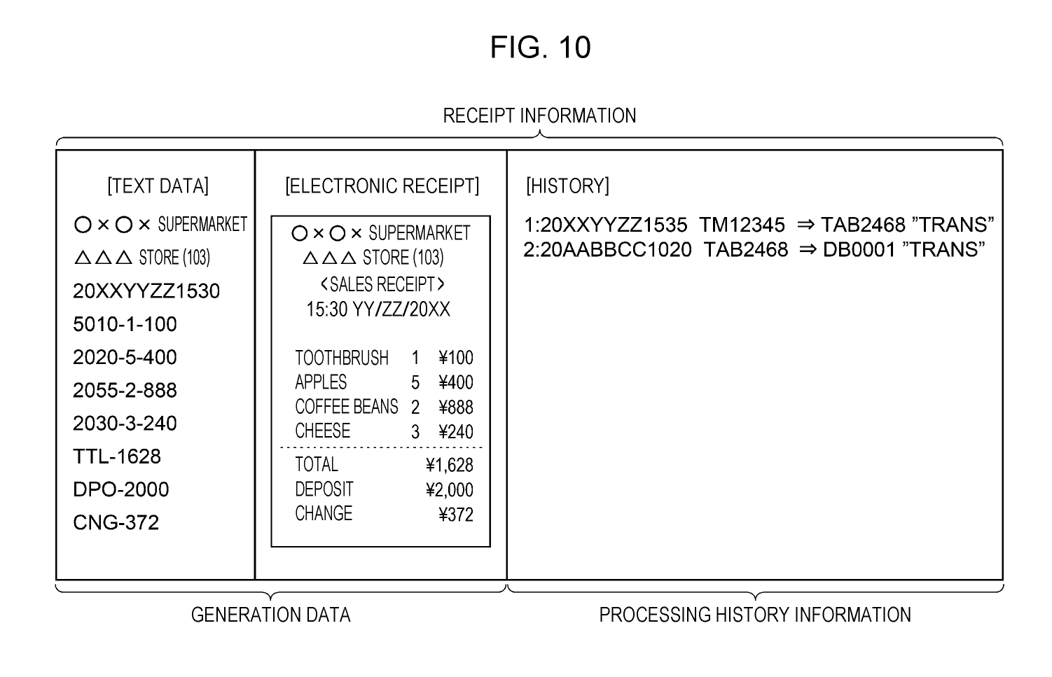

FIG. 10 is a diagram illustrating a specific example of the receipt information updated in step S72. As illustrated in FIG. 10, for the serial number “2” of the processing history information of the receipt information, “20AABBCC1020 TAB2468⇒DB0001“TRANS”” is recorded as the server save information added in step S71. That is to say, “20AABBCC1020 TAB2468⇒DB0001“TRANS”” indicates that the receipt information has been transferred (“TRANS”) from the smartphone 3 having the unique number “TAB2468” to the data server 7 having the unique number “DB0001” at “10:20 BB/CC/20AA”.

In this regard, in the present embodiment, the example in which the data server 7 saves the original receipt information, and the receipt information is deleted from the smartphone 3 (example of being transferred) has been described. However, it is possible to configure the server save processing 305 such that the data server 7 saves the original receipt information, and the smartphone 3 holds the receipt information that has been subjected to copied processing (example of being subjected to copy transmission). That is to say, after the smartphone 3 transmits the receipt information to the data server 7 in step S73, the smartphone 3 may perform delete processing of part of the data of the electronic receipt, or may perform add processing of the data 204 indicating that the electronic receipt was subjected to copy transmission in the past and hold the receipt information including the processed electronic receipt in the same manner as the receipt information illustrated in FIG. 9A and FIG. 9B.

Operation and Effect

As described above, according to the present embodiment, it is possible for the receipt printer 2 to print the receipt 25 as a printed matter or transmit the receipt information including the generation data generated in accordance with the receipt print information and the processing history information to the smartphone 3 as an external device. Further, since the processing history information includes the information indicating the details of the receipt information having been processed, it is possible for the smartphone 3 that has received the receipt information to perform processing for avoiding duplicate issues of the receipt in accordance with the processing history information.

Also, it is possible for the customer to obtain a receipt that is printed on the print medium 40 by the print processing 301 using the home printer 4 installed in an environment enabling the customer to easily use the home printer 4 all the time. Further, the form of the electronic receipt is changed by deletion of part of the data of the electronic receipt or addition of the data 203 indicating that the electronic receipt has been printed, and thus it is not possible to print the original (formal) receipt from the electronic receipt having a changed form. Accordingly, it is possible to avoid duplicate issues of the receipt. Also, since the printed information is added to the processing history information, it is possible for the smartphone 3 to confirm the contents of the processing history information and to determine whether or not the receipt can be printed. Accordingly, it is possible to avoid duplicate issues of the receipt.

Also, as illustrated in the transfer processing 302 and the copy transmission processing 303, it becomes possible to transfer or copy (copy transmission) the receipt information. In the transfer processing 302, the receipt information of the transmission source is deleted, and thus the uniqueness of the receipt information is guaranteed. In the copy transmission processing 303, the receipt information having been subjected to copied processing is held either by the transmission source or the transmission destination. Accordingly, unlike the original receipt information, with the receipt information having been subjected to copied processing, even if the electronic receipt included in the receipt information is printed, it is not possible to print the formal receipt, and thus it is possible to avoid duplicate issues of the receipt.

Also, with the receipt information processing system to which the invention is applied, it is possible to freely communicate the receipt information as electronic data between the devices that are communicably connected, and to guarantee the uniqueness of the receipt information. Thereby it is possible to avoid duplicate issues of the receipt as a voucher. That is to say, as illustrated in the data transmission processing 304, the POS data is captured from the text data included in the receipt information into a peripheral device, and thus as illustrated in the server save processing 305, it is possible to save the receipt information in the peripheral device.

Variations

As described above, a description has been given of the embodiments of the invention. However, it is possible to make, for example, the following variations without departing from the spirit and scope of the invention.

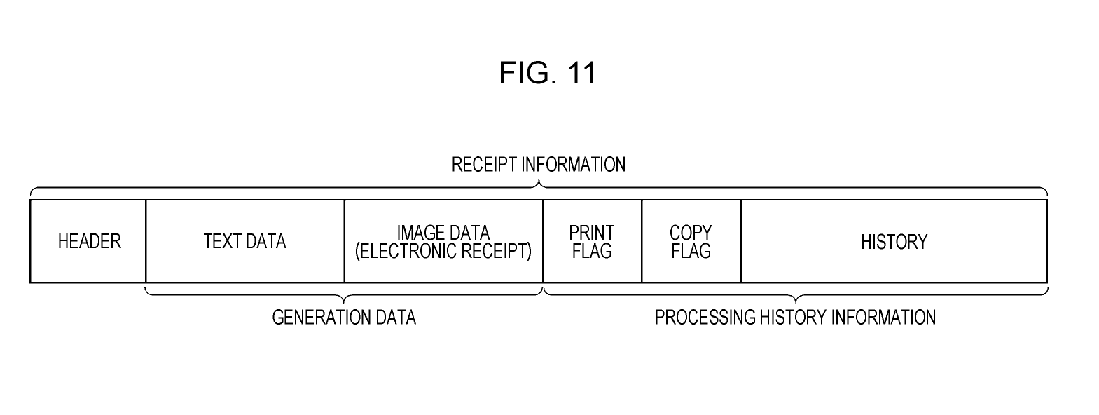

FIG. 11 is a diagram illustrating the structure of the receipt information, which is varied from the receipt information illustrated in FIG. 5. Specifically, the structure of the receipt information illustrated in FIG. 11 is produced by adding a header to the receipt information illustrated in FIG. 5 and adding a print flag and a copy flag to the processing history information.

A header indicates, for example, the total amount of data of the receipt information. Thereby, a header can be used as an index for a user terminal or a peripheral device, to which the receipt information is transmitted, to determine whether or not the receipt information can be received. As a result, if it is not possible for the user terminal and the peripheral device to receive the total amount of data, it is possible to divide the total amount of data or to give an alarm, or the like before receiving the receipt information. Accordingly, it is possible to avoid the occurrence of problems.

A print flag is one of the examples of printed information indicating that the electronic receipt has been printed (the receipt has been issued). For example, a print flag is one-bit data indicating “1” or “0” and is set to “1” if the electronic receipt has been printed. In this manner, when a user terminal or a peripheral device that holds receipt information determines whether or not the electronic receipt can be printed in step S42 (FIG. 4), it is possible to determine whether or not the electronic receipt can be printed by confirming the value of the print flag without searching the printed information from the information recorded for each serial number “n (n=1, 2, . . . )” in the processing history information. Accordingly, the processing efficiency is improved.

A copy flag is one of the examples of printed information indicating that the receipt information has been subjected to copy transmission. For example, a copy flag is one-bit data indicating “1” or “0” and is set to “1” if the receipt information has been subjected to copy transmission. In this manner, when a user terminal or a peripheral device that holds receipt information determines whether or not the electronic receipt can be printed in step S42 (FIG. 4), it is possible to determine whether or not the electronic receipt can be printed by confirming the value of the copy flag without searching for the information indicating that the receipt information has been copied and transmitted from the information recorded for each serial number “n (n=1, 2, . . . )” in the processing history information. Accordingly, the processing efficiency is improved.

As described above, descriptions have been given of the embodiments of the invention and the variations. However, the invention is not limited to the above-described embodiments and the variations can be realized by various configurations without departing from the spirit and scope of the invention. For example, it is possible to suitably replace or combine the technical features of the embodiments and the variations in order to solve part of or all of the problems described above or achieve part of or all of the advantages. Also, if the technical features are not described as indispensable in this specification, it is possible to suitable delete the technical features.

What is claimed is:

1. A receipt printer comprising:
a printing mechanism configured to print a receipt as a sales receipt;
a memory configured to store a control program; and
a processor configured to read the control program from the memory and execute the control program,
wherein the processor receives receipt print information including POS data regarding the purchases from a POS accounting apparatus for performing accounting processing regarding purchases made by a customer,
generates receipt information including generation data in accordance with the receipt print information and processing history information, and
performs at least one of processing for causing the printing mechanism to print the receipt in accordance with the receipt print information and processing for transmitting the receipt information to a external device different from the POS accounting apparatus, and
includes in the processing history information information indicating details of the receipt information having been processed.

2. The receipt printer according to claim 1, wherein the processor generates as the generation data at least one of text data in accordance with the POS data and image data of the receipt as an electronic receipt.

3. The receipt printer according to claim 1,
wherein if the processor has caused printing of the receipt, the processor includes in the processing history information printed information indicating completion of printing the receipt, and
if the processor transmits the receipt information to the external device, the processor includes in the processing history information at least one of information identifying the receipt printer of a transmission source, information identifying the external device of a transmission destination, and date and time information of transmission to the external device.

4. The receipt printer according to claim 3,
wherein the processing history information includes a print flag indicating whether or not the receipt has been printed, and
if the processor includes in the processing history information printed information indicating completion of printing the receipt, the processor sets the print flag to a state indicating completion of printing.

5. The receipt printer according to claim 2,
wherein if the processor has printed the receipt, the processor deletes at least part of the data of the electronic receipt from the generation data.

6. The receipt printer according to claim 2,
wherein if the processor has printed the receipt, the processor adds data indicating completion of printing the receipt to the electronic receipt.

7. A method of controlling a receipt printer including
a printing mechanism configured to print a receipt as a sales receipt,
a memory configured to store a control program, and
a processor configured to read the control program from the memory and execute the control program, the method comprising:
receiving receipt print information including POS data regarding the purchases from a POS accounting apparatus for performing accounting processing regarding purchases made by a customer;
generating receipt information including generation data in accordance with the receipt print information and processing history information;
performing at least one of processing for causing the printing mechanism to print the receipt in accordance with the receipt print information and processing for transmitting the receipt information to the external device different from the POS accounting apparatus; and
including in the processing history information information indicating details of the receipt information having been processed.
